(19) United States
(12) Patent Application Publication
(10) Pub. No.: US 2022/0081525 A1
(43) Pub. Date: Mar. 17, 2022

(54) POLYESTER FILM AND COATING LIQUID

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); CHENG-HUNG CHEN, TAIPEI (TW)

(21) Appl. No.: 17/383,662

(22) Filed: Jul. 23, 2021

(30) Foreign Application Priority Data
Sep. 16, 2020 (TW) 109131788

(51) Int. Cl. C08J 7/04; C09D 151/08; C09D 7/62; C09D 7/40; C09D 167/02

(52) U.S. Cl. CPC C08J 7/0427; C09D 151/08; C08J 2367/02; C09D 7/69; C09D 167/02; C09D 7/62

(57) ABSTRACT

A polyester film and coating liquid are provided. The polyester film includes a resin substrate and a coating layer. The coating layer is formed by coating a coating liquid on a side surface of the resin substrate and then drying the coating liquid. The coating liquid includes a mixed resin, a surface-modified filler particle solution, and water. Based on 100 parts by weight of coating liquid, a content range of the mixed resin is 2 to 40 parts by weight, a content range of the surface-modified filler particle solution is 0.05 to 30 parts by weight, and a content range of the water is within 50 to 85 parts by weight. The mixed resin includes a polyester resin, a polyurethane resin that is graft-modified by acrylate, and a crosslinking agent that are mutually mixed in a predetermined ratio, so that the coating liquid has a predetermined refractive index.

### CROSS-REFERENCE TO RELATED PATENT APPLICATION

This application claims the benefit of priority to Taiwan Patent Application No. 109131788, filed on Sep. 16, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film and a coating liquid, and more particularly to a polyester film and a coating liquid applicable in the field of optics.

### BACKGROUND OF THE DISCLOSURE

When a conventional polyester film is applied to an optical apparatus (e.g., a flat panel display), a UV glue having a high refractive index is required to be coated onto a side of the conventional polyester film, so that the conventional polyester film can provide an appropriate brightness. Although using the UV glue having the high refractive index can allow the conventional polyester film to provide the appropriate brightness, higher costs are still associated therewith.

### SUMMARY OF THE DISCLOSURE

In response to the above-referenced technical inadequacy, the present disclosure provides a polyester film and a coating liquid to improve on an issue of a conventional polyester film More specifically, when the conventional polyester film is applied to an optical apparatus (e.g., a flat panel display), a UV glue having a high refractive index is required so that the conventional polyester film can provide an appropriate brightness, which may involve excessive costs.

In one aspect, the present disclosure provides a polyester film including a resin substrate and a coating layer. The coating layer is coated on a side surface of the resin substrate. The coating layer is formed by coating a coating liquid onto the side surface of the resin substrate and drying the coating liquid. The coating liquid includes a mixed resin, a filler particle solution that is surface-modified, and water. Based on 100 parts by weight of the coating liquid, a content range of the mixed resin is 2 to 40 parts by weight, a content range of the filler particle solution is 0.05 to 30 parts by weight, and a content range of the water is 50 to 85 parts by weight. The mixed resin includes a polyester resin, a polyurethane resin that is graft-modified by acrylate, and a crosslinking agent, and in the mixed resin, the polyester resin, the polyurethane resin, and the crosslinking agent are mutually mixed in a predetermined ratio, so that the coating layer has a predetermined refractive index. The predetermined ratio in which the mixed resin, the polyester resin, the polyurethane resin, and the crosslinking agent are mutually mixed is within a range from 1:0.6:0.3 to 1:4:2.

In another aspect, the present disclosure provides a coating liquid that can be coated onto a side surface of a resin substrate and be dried to form a coating layer. The coating liquid includes a mixed resin, a filler particle solution that is surface-modified, and water. Based on 100 parts by weight of the coating liquid, a content range of the mixed resin is 2 to 40 parts by weight, a content range of the filler particle solution is 0.05 to 30 parts by weight, and a content range of the water is 50 to 85 parts by weight. The mixed resin includes a polyester resin, a polyurethane resin that is graft-modified by acrylate, and a crosslinking agent, and in the mixed resin, the polyester resin, the polyurethane resin, and the crosslinking agent are mutually mixed in a predetermined ratio, so that the coating layer has a predetermined refractive index. The predetermined ratio in which the mixed resin, the polyester resin, the polyurethane resin, and the crosslinking agent are mutually mixed is within a range from 1:0.6:0.3 to 1:4:2.

The coating liquid includes the mixed resin, the filler particle solution that is surface-modified, and water. Based on 100 parts by weight of the coating liquid, the content range of the mixed resin is 2 to 40 parts by weight, the content range of the filler particle solution is 0.05 to 30 parts by weight, and the content range of the water is 50 to 85 parts by weight. The mixed resin includes the polyester resin, the polyurethane resin that is graft-modified by acrylate, and the crosslinking agent, and in the mixed resin, the polyester resin, the polyurethane resin, and the crosslinking agent are mutually mixed in a predetermined ratio, so that the coating layer has a predetermined refractive index, and the predetermined ratio in which the mixed resin, the polyester resin, the polyurethane resin, and the crosslinking agent are mutually mixed is within a range from 1:0.6:0.3 to 1:4:2. Therefore, the polyester film of the present disclosure can provide a high brightness, a high light-transmittance, and a high haze without the UV glue having the high refractive index coated thereon, and the polyester film is applicable to the field of optics.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a polyester film according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

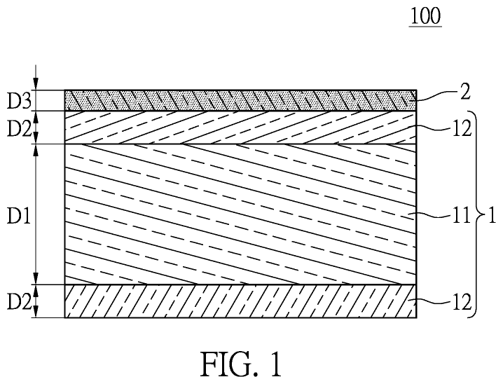

Referring to FIG. 1, FIG. 1 is a schematic view of a polyester film according to an embodiment of the present disclosure. The present embodiment of the present disclosure provides a polyester film 100. The polyester film 100 can provide a certain refractive index, and has properties such as a high brightness, a high light-transmittance, a high anti-adhesion temperature, and an excellent adhesion. Therefore, the polyester film 100 of the present disclosure is applicable in the field of optics. For example, the polyester film 100 can be used as a diffusion film, a brightness enhancing film, an anti-reflection film, or a protective film of a flat panel display, but the present disclosure is not limited thereto.

The polyester film 100 includes a resin substrate 1 and a coating layer 2 coated on a side surface of the resin substrate 1. The coating layer 2 can be formed by coating a coating liquid onto the side surface of the resin substrate 1 and then drying the coating liquid. It should be noted that in the present embodiment, the coating layer 2 is formed by coating the coating liquid onto the side surface of the resin substrate 1 and then drying the coating liquid, but the present disclosure is not limited thereto. For example, in other embodiments, the coating liquid can be independently used (e.g., be sold) or be coated onto other types of substrates.

In the present embodiment, the resin substrate 1 includes a first resin layer 11 and two second resin layers 12, and the two second resin layers 12 are respectively arranged at two opposite sides of the first resin layer 11, but the present disclosure is not limited thereto. In other words, in the present embodiment, the resin substrate 1 is in a three-layer structure where the first resin layer 11 is sandwiched between two second resin layers 12, but in other embodiments, the resin substrate 1 can be in a one-layer structure, a two-layer structure, or a multiple layer structure.

The first resin layer 11 includes polyethylene terephthalate (i.e., PET) and inorganic particle dispersed in the polyethylene terephthalate. The inorganic particle of the resin substrate 1 is at least one selected from the group consisting of aluminum oxide, aluminum hydroxide, silicon dioxide, titanium dioxide, zirconium oxide, calcium carbonate, magnesium carbonate, and barium sulfate, and a particle size of the inorganic particle of the resin substrate 1 is within a range from 0.1 μm to 10 μm.

Based on 100 parts by weight of the first resin layer 11, a content range of the polyethylene terephthalate is 50 to 95 parts by weight, and a content range of the inorganic particle is 5 to 50 parts by weight. Through the material selection, the particle size, and the content range of the inorganic particle of the resin substrate 1 in cooperation with the content range of the polyethylene terephthalate, the inorganic particle can be more evenly dispersed in the polyethylene terephthalate.

Each of the second resin layers 12 includes the polyethylene terephthalate and the inorganic particle dispersed in the polyethylene terephthalate. In each of the second resin layers 12, based on 100 parts by weight of each of the second resin layers 12, a content range of the polyethylene terephthalate is 50 to 95 parts by weight, and a content range of the inorganic particle is 5 to 50 parts by weight.

It is worth mentioning that, although the inorganic particle in the first resin layer 11 and the inorganic particle in any one of the second resin layers 12 are selected from a same group, but in a practical application, the inorganic particle in the first resin layer 11 and the inorganic particle in any one of the second resin layers 12 are not limited to being the same, and the inorganic particle in one of the second resin layers 12 and the inorganic particle in another one of the second resin layers 12 are not limited to being the same. For example, the inorganic particle in the first resin layer 11 can be aluminum oxide, the inorganic particle in the second resin layers 12 can be silicon dioxide, but the present disclosure is not limited thereto.

A thickness D1 of the first resin layer 11 is within a range from 50 μm to 300 μm, and a thickness D2 of any one of the second resin layers 12 is within a range from 1 μm to 50 μm. In other words, the thickness D1 of the first resin layer 11 is greater than or equal to the thickness D2 of any one of the second resin layers 12. In the present embodiment, the two second resin layers 12 have the same thicknesses D2, and the thickness D2 of any one of the second resin layers 12 is 16.67% to 100% of the thickness D1 of the first resin layer 11, but the present disclosure is not limited thereto.

The coating liquid includes a mixed resin, a filler particle solution that is surface-modified, and water, based on 100 parts by weight of the coating liquid, a content range of the mixed resin is 2 to 40 parts by weight, a content range of the filler particle solution is 0.05 to 30 parts by weight, and a content range of the water is 50 to 85 parts by weight.

In addition, the coating liquid can further include an additive. Based on 100 parts by weight of the coating liquid, a content range of the additive is 0.05 to 10 parts by weight, and the additive is a dispersant, an antifoaming agent, a surface wetting agent, an auxiliary agent, a catalyst, or a co-solvent. Since the coating liquid includes the additive, the mixed resin, the filler particle solution, and the water can be more evenly mixed with each other, thereby avoiding negatively affecting the coating layer 2 by an uneven mixing of each component.

In the coating liquid, the mixed resin includes a polyester resin, a polyurethane resin that is graft-modified by acrylate, and a crosslinking agent, and in the mixed resin, the polyester resin, the polyurethane resin, and the crosslinking agent are mutually mixed in a predetermined ratio, so that the coating layer 2 has a predetermined refractive index.

More specifically, the polyester resin can be a water-soluble or water-dispersible polyester resin polymerized by acid and alcohol as follows. The acid can be a dicarboxylic acid having a sulfonic acid group, and the dicarboxylic acid is at least one selected from the group consisting of sulfonic acid isophthalic acid, 5-sulfonic acid isophthalic acid, 2-sulfonic acid isophthalic acid, and 4-sulfonic acid isophthalic acid. Or, the acid can be a carboxylic acid without a sulfonic acid group, and the carboxylic acid is at least one selected from the group consisting of aromatic, aliphatic or cycloaliphatic dicarboxylic acid or multifunctional acid. The alcohol is at least one selected from the group consisting of ethylene glycol, diethylene glycol, polyethylene glycol, propylene glycol, 1,3-propanediol, polypropylene glycol, 1,4-butanediol, 1,5-pentanediol, 1,6-hexanediol, cyclic hexane-1,2-diol, 1,3 cyclohexane-dimethanol, 1,4 cyclohexane-dimethanol, cyclohexane-1,4-diol. The polyurethane resin that is graft-modified by acrylate can be the following monomers that are graft-modified, based on 100 parts by weight of total monomers: (a) 90 to 95 parts by weight of a (meth)acrylate having an alkyl group; (b) 4 to 9 parts by weight of a (meth)acrylate having a hydroxyl group; and (c) 1 to 5 parts by weight of a vinyl monomer having a carboxyl group. The vinyl monomer having the carboxyl group is at least one selected from the group consisting of acrylic acid, methacrylic acid, itaconic acid, crotonic acid, maleic acid, fumaric acid and maleic anhydride. The crosslinking agent is at least one selected from the group consisting of melamine resin, melamine modified resin, a carbodiimide crosslinking agent, and an oxazoline crosslinking agent.

In the mixed resin, the predetermined ratio in which the polyester resin, the polyurethane resin, and the crosslinking agent being mutually mixed in is within a range from 1:0.6:0.3 to 1:4:2. In other words, based on 100 parts by weight of the mixed resin, a content range of the polyester resin is 19 to 50 parts by weight, a content range of the polyurethane resin is 30 to 80 parts by weight, and a content range of the crosslinking agent is 10 to 40 parts by weight. In the present embodiment, a thickness D3 of the coating layer 2 is within a range from 0.05 μm to 0.5 μm, and the predetermined refractive index of the coating layer 2 is within a range from 1.5 to 1.65, but the present disclosure is not limited thereto. Since in the mixed resin, the polyester resin, the polyurethane resin, and the crosslinking agent are mutually mixed in the predetermined ratio, the coating layer 2 can have the predetermined refractive index within the range from 1.5 to 1.65, and the polyester film 100 is accordingly applicable to an optical apparatus such as the flat panel display.

In the coating liquid, the filler particle solution includes filler particle and surface modification agent, and based on 100 parts by weight of the filler particle solution, a content range of the filler particle is 0.05 to 30 parts by weight, and a content range of the surface modification agent is 0.01 to 3 parts by weight. The filler particle is at least one selected from the group consisting of silicon dioxide, titanium dioxide, aluminum oxide, calcium carbonate, calcium phosphate, and barium sulfate, and the surface modification agent is at least one selected from the group consisting of a vinyl silane coupling agent, an epoxy silane coupling agent, a styryl silane coupling agent, a methacrylic oxysilane coupling agent, an acrylic oxysilane coupling agent, an aminosilane coupling agent, an isocyanurate silane coupling agent, a urea silane coupling agent, and an isocyanate silane coupling agent.

It is worth mentioning that, the filler particle solution can be more evenly dispersed in the coating liquid after being surface-modified. In contrast, if the filler particle solution is not surface-modified, a gathering phenomenon may easily occur since the filler particle in the filler particle solution is not well dispersed, and the coating layer 2 formed by the coating liquid may be unable to provide an appropriate refractive index, brightness, light-transmittance, haze, anti-adhesion temperature, and adhesion. In other words, if the filler particle solution is not surface-modified, the coating layer 2 formed by the coating liquid may not provide an appropriate refractive index, so that the polyester film 100 is less applicable in the optical apparatus.

### Experimental Results

Hereinafter, exemplary examples 1 to 5 and comparative examples 1 to 3 are described in detail. However, the exemplary examples are only used to aid in understanding of the present disclosure, and the scope of the present disclosure is not limited to these examples.

In the exemplary example 1, the mixed resin and the filler particle solution that is surface-modified are mixed into water to form the coating liquid, and based on 100 parts by weight of the coating liquid, a content range of the water is 68 parts by weight, a content range of the mixed resin is 22 parts by weight, and a content range of the filler particle solution is 10 parts by weight. Further content ranges and ratios can be referred to in Table 1 below. The coating liquid is coated onto a PET substrate (i.e., the resin substrate 1), and after the PET substrate is biaxially-stretched, an optical property, an adhesion (tested using a cross cut test) between the coating layer and a UV brightening layer, an anti-adhesion, and a brightness increase value of the PET substrate are measured.

In the exemplary example 2, the mixed resin and the filler particle solution that is surface-modified are mixed into water to form the coating liquid, and based on 100 parts by weight of the coating liquid, a content range of the water is 68 parts by weight, a content range of the mixed resin is 22 parts by weight, and a content range of the filler particle solution is 10 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the exemplary example 3, the mixed resin and the filler particle solution that is surface-modified are mixed into water to form the coating liquid, and based on 100 parts by weight of the coating liquid, a content range of the water is 69 parts by weight, a content range of the mixed resin is 21 parts by weight, and a content range of the filler particle solution is 10 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the exemplary example 4, the mixed resin and the filler particle solution that is surface-modified are mixed into water to form the coating liquid, and based on 100 parts by weight of the coating liquid, a content range of the water is 58 parts by weight, a content range of the mixed resin is 22 parts by weight, and a content range of the filler particle solution is 20 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the exemplary example 5, the mixed resin and the filler particle solution that is surface-modified are mixed into water to form the coating liquid, and based on 100 parts by weight of the coating liquid, a content range of the water is 48 parts by weight, a content range of the mixed resin is 22 parts by weight, and a content range of the filler particle solution is 30 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the comparative example 1, the mixed resin and the filler particle solution that is surface-modified are mixed into water to form the coating liquid, and based on 100 parts by weight of the coating liquid, a content range of the water is 68 parts by weight, a content range of the mixed resin is 22 parts by weight, and a content range of the filler particle solution is 10 parts by weight. Further content ranges and ratios can be referred to in Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the comparative example 2, the mixed resin and the filler particle solution that is surface-modified are mixed into water to form the coating liquid, and based on 100 parts by weight of the coating liquid, a content range of the water is 77.97 parts by weight, a content range of the mixed resin is 22 parts by weight, and a content range of the filler particle solution is 0.03 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

In the comparative example 3, the mixed resin and the filler particle solution that is surface-modified are mixed into water to form the coating liquid, and based on 100 parts by weight of the coating liquid, a content range of the water is 38 parts by weight, a content range of the mixed resin is 22 parts by weight, and a content range of the filler particle solution is 40 parts by weight. Further content ranges and ratios can be referred to Table 1 below. The coating liquid is coated onto a PET substrate, and after the PET substrate is biaxially-stretched, an optical property, an adhesion between the coating layer and a UV brightening layer, an anti-adhesion, and a brightness increase value of the PET substrate are measured.

The content of each component, the thickness, the refractive index, the brightness, the light-transmittance, the haze, the anti-adhesion temperature, and the adhesion of the polyester film 100 in each of the exemplary examples 1 to 5 and the comparative examples 1 to 3 are shown in Table 1 below, and the relevant test methods are described below.

The refractive index test includes: using FE-3000 optical machine to analyze a refractive spectrum of the coating layer of the PET substrate, so as to measure the refractive index.

The brightness test includes: arranging two polyester films that are perpendicularly overlapping with each other into a 15.6″ backlight module, using a brightness meter to measure a brightness, and comparing the brightness with a standard brightness to obtain the brightness increase value.

The light-transmittance test includes: using a haze meter to measure the light-transmittance of the coating layer of the polyester film 100.

The haze test includes: using the haze meter to measure the haze of the coating layer of the polyester film 100.

The anti-adhesion temperature test includes: taking two polyester films, contacting a coating surface of one of the two polyester films with a non-coating surface of the other one of the two polyester films, hot pressing the two polyester films with a load of 2 kilograms for 2 minutes, and detaching the two polyester films to confirm whether any glues remain at an interface there-between. The higher a hot pressing temperature is, the better the anti-adhesion of the polyester film 100 is.

The adhesion test includes: coating a UV brightness layer onto the polyester film 100, performing a cross cut test, and counting the quantity of detaching grids. The adhesion is scored from 0B to 5B, with 0B being the worst, and 5B being the best.

Table 1 shows the content of each component and test results of the exemplary and comparative examples as follows.

| | | Exemplary | Exemplary | Exemplary | Exemplary | Exemplary |
|---|---|---|---|---|---|---|
| Items | | example 1 | example 2 | example 3 | example 4 | example 5 |
| Parameter | Content of mixedresin (wt %) | 22 | 22 | 21 | 22 | 22 |
| of each | Content of filler particle | 10 | 10 | 10 | 20 | 30 |
| component | solution (wt %) | | | | | |
| | Content of water (wt %) | 68 | 68 | 69 | 58 | 48 |
| | Content of polyester resin in | 11.5 | 5.5 | 3.0 | 5.5 | 5.5 |
| | mixed resin (wt %) | | | | | |
| | Content of polyurethane resin | 7.0 | 11.0 | 12.0 | 11.0 | 11.0 |
| | in mixed resin (wt %) | | | | | |
| | Content of crosslinking agent | 3.5 | 5.5 | 6.0 | 5.5 | 5.5 |
| | in mixed resin (wt %) | | | | | |
| | Predetermined ratio where | 1:0.6:0.3 | 1:2:1 | 1:4:2 | 1:2:1 | 1:2:1 |
| | polyester resin, polyurethane | | | | | |
| | resin, and crosslinking agent | | | | | |
| | mutually mixed | | | | | |
| | Content of filler particle in | 3.0 | 3.0 | 3.0 | 6.0 | 9.0 |
| | filler particle solution (wt %) | | | | | |
| | Content of surface modification | 0.30 | 0.30 | 0.30 | 0.60 | 0.90 |
| | agent in filler particle solution | | | | | |
| | (wt %) | | | | | |
| | Thickness of first resin layer | 95 | 95 | 95 | 95 | 95 |
| | (μm) | | | | | |
| | Thickness of second resin layer | 5 | 5 | 5 | 5 | 5 |
| | (μm) | | | | | |
| | Thickness of coating layer (μm) | 0.1 | 0.1 | 0.1 | 0.1 | 0.1 |
| Test results | Refractive index of coating layer | 1.52 | 1.54 | 1.56 | 1.54 | 1.53 |
| | Brightness increase value of | +1.3% | +1.0% | +0.9% | +1.0% | +1.2% |
| | polyester film | | | | | |
| | Light-transmittance of polyester | 90.68 | 90.85 | 90.77 | 91.30 | 91.55 |
| | film (%) | | | | | |
| | Haze of polyester film (%) | 0.67 | 0.58 | 0.63 | 0.63 | 0.83 |
| | Anti-adhesion temperature of | 100 | 100 | 100 | 110 | 120 |
| | polyester film(° C.) | | | | | |
| | Adhesion of polyester film | 5B | 5B | 5B | 5B | 5B |

| | | Comparative | Comparative | Comparative |
|---|---|---|---|---|
| Items | | example 1 | example 2 | example 3 |
| Parameter | Content of mixed resin(wt %) | 22 | 22 | 22 |
| of each | Content of filler particle | 10 | 0.03 | 40 |
| component | solution(wt %) | | | |
| | Content of water (wt %) | 68 | 77.97 | 38 |
| | Content of polyester resin in | 16.9 | 5.5 | 5.5 |
| | mixed resin (wt %) | | | |
| | Content of polyurethane | 3.4 | 11.0 | 11.0 |
| | resin in mixed resin (wt %) | | | |
| | Content of crosslinking agent | 1.7 | 5.5 | 5.5 |
| | in mixed resin (wt %) | | | |
| | Predetermined ratio where | 1:0.2:0.1 | 1:2:1 | 1:2:1 |
| | polyester resin, polyurethane | | | |
| | resin, and crosslinking agent | | | |
| | mutually mixed | | | |
| | Content of filler particle in | 3.0 | 0.9 | 12.0 |
| | filler particle solution (wt %) | | | |
| | Content of surface | 0.30 | 0.09 | 1.20 |
| | modification agent in filler | | | |
| | particle solution (wt %) | | | |
| | Thickness of first resin layer | 95 | 95 | 95 |
| | (μm) | | | |
| | Thickness of second resin | 5 | 5 | 5 |
| | layer (μm) | | | |
| | Thickness of coating layer | 0.1 | 0.1 | 0.1 |
| | (μm) | | | |
| Test results | Refractive index of coating | 1.50 | 1.55 | 1.52 |
| | layer | | | |
| | Brightness increase value of | +0.9% | +0.3% | +0.4% |
| | polyester film | | | |
| | Light-transmittance of | 91.25 | 90.68 | 91.38 |
| | polyester film (%) | | | |
| | Haze of polyester film (%) | 0.61 | 0.75 | 4.35 |
| | Anti-adhesion temperature of | 110 | 60 | 120 |
| | polyester film(° C.) | | | |
| | Adhesion of polyester film | 1B | 5B | 2B |

### Discussion of Test Results

In the exemplary example 1, the polyester resin is added to adjust the refractive index of the coating layer, the brightness increase value is greater than 1.0%, and the adhesion and low haze are maintained. In the comparative example 1, since the content of the polyester resin is excessive, the refractive index of the coating layer decreases, and the adhesion between the polyester resin and the UV brightness layer is relatively poor (the adhesion is 1B). In each of the exemplary examples 2, 4 and 5, since the content of the filler particle solution is increased, the refractive index of the coating layer is adjusted, the brightness increase value is increased to greater than 1.0%, and the anti-adhesion temperature is increased. In the comparative example 2, since the content of the filler particle solution is relatively low, the brightness increase value is poor, and the anti-adhesion temperature is low. In the comparative example 3, since the content of the filler particle solution is excessive, the brightness increase value is poor, the haze is increased, and the adhesion is poor (the adhesion is 2B).

As shown from the exemplary example 1 to the exemplary example 5, the polyester films of the exemplary example 1 to the exemplary example 5 can provide the brightness increase values within a range from +0.9% to +1.3%, the light-transmittances within a range from 90.68% to 91.55%, and the haze within a range from 0.58% to 0.83%, the anti-adhesion temperatures within a range from 100° C. to 120° C., and the coating layers can have the refractive indices within a range from 1.52 to 1.56.

### Beneficial Effects of the Embodiments

In conclusion, since the coating liquid includes the mixed resin, the filler particle solution that is surface-modified, and water. Based on 100 parts by weight of the coating liquid, the content range of the mixed resin is 2 to 40 parts by weight, the content range of the filler particle solution is 0.05 to 30 parts by weight, and the content range of the water is 50 to 85 parts by weight, the mixed resin includes the polyester resin, the polyurethane resin that is graft-modified by acrylate, and the crosslinking agent, in the mixed resin, the polyester resin, the polyurethane resin, and the crosslinking agent are mutually mixed in a predetermined ratio, so that the coating layer has a predetermined refractive index, and the predetermined ratio in which the mixed resin, the polyester resin, the polyurethane resin, and the crosslinking agent are mutually mixed is within a range from 1:0.6:0.3 to 1:4:2, the polyester film of the present disclosure can provide a high brightness, a high light-transmittance, and a high haze without the UV glue having the high refractive index coated thereon, and the polyester film is applicable to the field of optics.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyester film, comprising:
a resin substrate; and
a coating layer coated on a side surface of the resin substrate, wherein the coating layer is formed by coating a coating liquid onto the side surface of the resin substrate and drying the coating liquid,
wherein the coating liquid includes a mixed resin, a filler particle solution that is surface-modified, and water, and wherein, based on 100 parts by weight of the coating liquid, a content range of the mixed resin is 2 to 40 parts by weight, a content range of the filler particle solution is 0.05 to 30 parts by weight, and a content range of the water is 50 to 85 parts by weight, and
wherein the mixed resin includes a polyester resin, a polyurethane resin that is graft-modified by acrylate, and a crosslinking agent, and in the mixed resin, the polyester resin, the polyurethane resin, and the crosslinking agent are mutually mixed in a predetermined ratio, so that the coating layer has a predetermined refractive index, and wherein the predetermined ratio in which the mixed resin, the polyester resin, the polyurethane resin, and the crosslinking agent are mutually mixed is within a range from 1:0.6:0.3 to 1:4:2.

2. The polyester film according to claim 1, wherein the resin substrate includes a first resin layer and two second resin layers, wherein the first resin layer includes polyethylene terephthalate and inorganic particle, based on 100 parts by weight of the first resin layer, a content range of the polyethylene terephthalate is 50 to 95 parts by weight, and a content range of the inorganic particle is 5 to 50 parts by weight, wherein the two second resin layers are respectively arranged at two opposite sides of the first resin layer, and each of the second resin layers includes the polyethylene terephthalate and the inorganic particle, and wherein, in each of the second resin layers, based on 100 parts by weight of each of the second resin layers, a content range of the polyethylene terephthalate is 50 to 95 parts by weight, and a content range of the inorganic particle is 5 to 50 parts by weight.

3. The polyester film according to claim 2, wherein a thickness of the first resin layer is within a range from 50 μm to 300 μm, a thickness of each of the second resin layers is within a range from 1 μm to 50 μm, and a thickness of the coating layer is within a range from 0.05 μm to 0.5 μm.

4. The polyester film according to claim 1, wherein the predetermined refractive index of the coating layer is within a range from 1.5 to 1.65.

5. The polyester film according to claim 1, wherein, in the coating liquid, the filler particle solution includes filler particles and a surface modification agent, based on 100 parts by weight of the filler particle solution, a content range of the filler particle is 0.05 to 30 parts by weight, and a content range of the surface modification agent is 0.01 to 3 parts by weight, wherein the filler particle is at least one selected from the group consisting of silicon dioxide, titanium dioxide, aluminum oxide, calcium carbonate, calcium phosphate, and barium sulfate, and wherein the surface modification agent is at least one selected from the group consisting of a vinyl silane coupling agent, an epoxy silane coupling agent, a styryl silane coupling agent, a methacrylic oxysilane coupling agent, an acrylic oxysilane coupling agent, an aminosilane coupling agent, an isocyanurate silane coupling agent, a urea silane coupling agent, and an isocyanate silane coupling agent.

6. The polyester film according to claim 1, wherein the inorganic particle of the resin substrate is at least one selected from the group consisting of aluminum oxide, aluminum hydroxide, silicon dioxide, titanium dioxide, zirconium oxide, calcium carbonate, magnesium carbonate, and barium sulfate, and a particle size of the inorganic particle of the resin substrate is within a range from 0.1 μm to 10 μm.

7. The polyester film according to claim 1, wherein the coating liquid further includes an additive, based on 100 parts by weight of the coating liquid, a content range of the additive is 0.05 to 10 parts by weight, and the additive is a dispersant, an antifoaming agent, a surface wetting agent, an auxiliary agent, a catalyst, or a co-solvent.

8. A coating liquid adapted for being coated onto a side surface of a resin substrate and being dried to form a coating layer, the coating liquid comprising:
a mixed resin;
a filler particle solution that is surface-modified; and
water;
wherein, based on 100 parts by weight of the coating liquid, a content range of the mixed resin is 2 to 40 parts by weight, a content range of the filler particle solution is 0.05 to 30 parts by weight, and a content range of the water is 50 to 85 parts by weight, and
wherein the mixed resin includes a polyester resin, a polyurethane resin that is graft-modified by acrylate, and a crosslinking agent, and in the mixed resin, the polyester resin, the polyurethane resin, and the crosslinking agent are mutually mixed in a predetermined ratio, so that the coating layer has a predetermined refractive index, and wherein the predetermined ratio in which the mixed resin, the polyester resin, the polyurethane resin, and the crosslinking agent are mutually mixed is within a range from 1:0.6:0.3 to 1:4:2.

9. The coating liquid according to claim 8, wherein, in the coating liquid, the filler particle solution includes filler particles and a surface modification agent, based on 100 parts by weight of the filler particle solution, a content range of the filler particle is 0.05 to 30 parts by weight, and a content range of the surface modification agent is 0.01 to 3 parts by weight, wherein the filler particle is at least one selected from the group consisting of silicon dioxide, titanium dioxide, aluminum oxide, calcium carbonate, calcium phosphate, and barium sulfate, and wherein the surface modification agent is at least one selected from the group consisting of a vinyl silane coupling agent, an epoxy silane coupling agent, a styryl silane coupling agent, a methacrylic oxysilane coupling agent, an acrylic oxysilane coupling agent, an aminosilane coupling agent, an isocyanurate silane coupling agent, a urea silane coupling agent, and an isocyanate silane coupling agent, and wherein the coating liquid further includes an additive, a content range of the additive is 0.05 to 10 parts by weight based on 100 parts by weight of the coating liquid, and the additive is a dispersant, an antifoaming agent, a surface wetting agent, an auxiliary agent, a catalyst, or a co-solvent.

10. The coating liquid according to claim 8, wherein the predetermined refractive index of the coating layer is within a range from 1.5 to 1.65.
